(19) United States
(12) Patent Application Publication
(10) Pub. No.: US 2014/0213427 A1
(43) Pub. Date: Jul. 31, 2014

(54) Photocatalyst for the Reduction of Carbon Dioxide

(71) Applicant: Sunpower Technologies LLC, (US)

(72) Inventor: Daniel Landry, Redondo Beach, CA (US)

(73) Assignee: Sunpower Technologies LLC, San Marcos, CA (US)

(21) Appl. No.: 13/755,786

(22) Filed: Jan. 31, 2013

(51) Int. Cl. B01J 27/04

(52) U.S. Cl. CPC B01J 27/04
USPC 502/1

(57) ABSTRACT

The present disclosure relates to a method and composition for forming photocatalytic capped colloidal nanocrystals which may include semiconductor nanocrystals and inorganic capping agents as photocatalysts. Photocatalytic capped colloidal nanocrystals may be deposited on a substrate and treated to form a photoactive material which may be employed in a plurality of photocatalytic energy conversion applications such as the photocatalytic reduction of carbon dioxide. Different semiconductor materials, shapes and sizes may be combined when forming photocatalytic capped colloidal nanocrystals, allowing band gaps to be tuned and expand the range of wavelengths of sunlight usable by the photoactive material. The disclosed photocatalytic capped colloidal nanocrystals, within the photoactive material, may also exhibit a higher efficiency of solar energy conversion process, derived from a higher surface area of the semiconductor nanocrystals within photocatalytic capped colloidal nanocrystals available for the absorption of sunlight and enhancement of charge carrier dynamics.

### BACKGROUND

1. Technical Field

The present disclosure relates in general to photoactive materials employed in energy conversion applications, and more specifically to compositions and methods to form photocatalytic capped colloidal nanocrystals which may function as a photoactive material employed in photocatalytic energy conversion applications such as in the photocatalytic reduction of carbon dioxide (CO₂).

2. Background Information

Solar photocatalytic reduction of carbon dioxide to various higher energy products, so as to store solar energy as chemical energy and create renewable fuels, may offer a way to decrease atmospheric concentrations of carbon dioxide emissions. One way to accomplish this conversion is through the light-driven reduction of carbon dioxide into methane (CH₄). The principles of photocatalytic carbon dioxide reduction require high surface areas for electron excitation and collection, and the use of nanocatalysts with high surface to volume ratio is a favorable match. Semiconductor nanocrystals can improve photocatalysis through the combined effects of quantum confinement and unique surface morphologies. Surface modification of nanosized catalysts may affect redox potentials, and may be used to enhance the efficiency of charge transfer and charge separation.

Nanometer-scaled composites provide the opportunity to combine useful attributes of two or more materials within a single composite or to generate entirely new properties as a result of the intermixing of two or more materials. Semiconductor nanocrystals also provide an improved degree of electronic and structural flexibility, primarily exemplified by the ability to continuously tailor the size of the particles and therefore, via quantum confinement effects, the electronic properties of the particles. An appropriately-tailored inorganic nanocomposite may provide outstanding thermoelectric characteristics. Inorganic nanocomposites may also exhibit high tunability.

There is still a need for improvement in this field, including the need for development of improved materials and devices that may operate with higher energy conversion efficiency for alternative fuel generation. A solar energy based technology to recycle carbon dioxide into readily transportable hydrocarbon fuel may reduce atmospheric carbon dioxide levels and may partly fulfill energy demands within the existing hydrocarbon based fuel economy.

It is an object of the present disclosure to provide embodiments for the composition and fabrication of photoactive materials that may exhibit higher solar energy conversion efficiency for energy production of clean fuels such as methane.

### SUMMARY

Aspects of the current disclosure are a composition and method for forming photocatalytic capped colloidal nanocrystals which may be employed as photoactive material in energy conversion applications are disclosed. The method may include semiconductor nanocrystals capped with inorganic capping agents in order to form a photocatalytic capped colloidal nanocrystal composition that may be deposited on a substrate and treated to produce a solid matrix of photoactive material. The photoactive material may be employed in the presence of sunlight and hydrogen to initiate redox reactions necessary for reducing carbon dioxide into methane and water.

The method for producing photocatalytic capped colloidal nanocrystals may include semiconductor nanocrystals synthesis and substituting organic capping agents with inorganic capping agents. To synthesize semiconductor nanocrystals, a semiconductor nanocrystal precursor and an organic solvent may react to produce organic capped semiconductor nanocrystals. In order to substitute organic capping agents with inorganic capping agents, the inorganic capping agent may be dissolved in an inorganic solvent, a first solvent, while the organic capped semiconductor nanocrystals may be dissolved in an immiscible, generally organic solvent, a second solvent. These two solutions are then combined in a single reaction vessel. The semiconductor nanocrystal reacts with the inorganic capping agent at or near the solvent boundary, the region where the two solvents meet, and a portion of the organic capping agent is replaced with the inorganic capping agent. That is, the inorganic capping agent may displace an organic capping agent from a surface of the semiconductor nanocrystal and the inorganic capping agent may bind to the surface of the semiconductor nanocrystal. This process continues until equilibrium is established between the inorganic capping agent on a semiconductor nanocrystal and the free inorganic capping agent. The semiconductor nanocrystals obtained after the capping agents exchange may be stable for a few days, after which photocatalytic capped colloidal nanocrystals may precipitate out of the solution.

In accordance to an embodiment, the photocatalytic capped colloidal nanocrystals (e.g. noble metals, niquel, copper, titanium dioxide, zinc sulfide and mixtures thereof) composition may be deposited on a substrate as thin or bulk films by a variety of techniques with short or long range ordering of photocatalytic capped colloidal nanocrystals. Additionally, the deposited photocatalytic capped colloidal nanocrystals composition can be thermally treated to anneal and form inorganic matrices with embedded photocatalytic capped colloidal nanocrystals. The annealed composition can have ordered arrays of photocatalytic capped colloidal nanocrystals in a solid state matrix, forming a photoactive material that may be used to reduce carbon dioxide in presence of sunlight. An effect of employing the methods of fabrication and deposition of the present disclosure may be the cost efficiency achieved due to low temperature requirements during semiconductor nanocrystals synthesis and inorganic capping of semiconductor nanocrystals, and simple/low cost methods of deposition.

In another embodiment, deposition on a substrate may not be needed. Accordingly, the photocatalytic capped colloidal nanocrystals composition may be deposited into a crucible to be then annealed and subsequently ground into particles and sintered together to form the photoactive material that may be deposited on a surface where the photoactive material may adhere. In another embodiment, ground particles of photocatalytic capped colloidal nanocrystals may be used directly as a photoactive material.

According to various embodiments, the disclosed photocatalytic capped colloidal nanocrystals in the photoactive material may include different configurations, such as spherical, tetrapod, core/shell, graphene, carbon nanotubes, nanorods, nanowires, nanosprings and nanodendritic, among others. Varying the configuration of photocatalytic capped colloidal nanocrystals may be achieved by changing the reaction time, reaction temperature profile, or structure of organic capping agents to passivate the surface of semiconductor nanocrystals during growth. In addition, the chemistry of the organic or inorganic capping agents may control several system parameters, such as the growth rate, the shape, and the dispersibility of semiconductor nanocrystals in the solvents, and even the excited state lifetimes of charge carriers in semiconductor nanocrystals.

Materials of the semiconductor nanocrystals within the photocatalytic capped colloidal nanocrystals may be selected in accordance with the irradiation wavelength. Changing the materials and shapes of semiconductor nanocrystals may enable tuning of the band-gap and band-offsets to expand the range of wavelengths usable by the photoactive material. Absorbance wavelengths and enhancement of carrier dynamics may also be increased due to high surface areas of the semiconductor nanocrystals.

The photoactive material may be submerged in a reaction vessel containing hydrogen so that a carbon dioxide reduction process may take place. The structure of the inorganic capping agents of the photocatalytic capped colloidal nanocrystals in the photoactive material may speed up the reaction by quickly transferring charge carriers sent by semiconductor nanocrystals to carbon dioxide. In addition, there may be a higher production of electrons and holes being used in redox reactions; because photocatalytic capped colloidal nanocrystals in the photocatalytic material can be designed to separate holes and electrons immediately upon formation, thus reducing the probability of electrons and holes recombining which would reduce availability in the reactions. Consequently, the redox reaction and carbon dioxide reduction process may occur at a faster and more efficient rate.

In one embodiment, a photocatalytic material comprises: a colloidal semiconductor nanocrystal; and a photocatalytic capping agent that binds to a surface of the semicondutor nanocrystal, wherein the photocatalytic capping agent is an inorganic capping agent.

In another embodiment, a photocatalytic capped collodial nanocrystal comprises: a first semiconductor nanocrystal; a second semiconductor nanocrystal bonded to the first semiconductor nanocrystal; a first inorganic capping agent that caps the first semiconductor nanocrystal; and a second inorganic capping agent that caps the second semiconductor nanocrystal.

In another embodiment, a method for forming a photocatalytic capped collodial nanocrystal comprises: reacting a semiconductor nanocrystals precursor and an organic solvent to produce organic capped semiconductor nanocrystals in a non-polar solution; dissolving an inorganic capping agent in an immiscible, polar solvent to form a polar solution, wherein the inorganic capping agent is a photocatalytic capping agent; combining the polar solution and the non-polar solution in a reaction vessel; replacing the organic capping agent with the inorganic capping agent to form inorganic capped semiconductor nanocrystals; purifying the inorganic capped semiconductor nanocrystals; depositing the inorganic capped semiconductor nanocrystals on a porous substrate; heating the deposited inorganic capped semiconductor nanocrystals according to a thermal treatment; and annealing the inorganic capped semiconductor nanocrystals to form inorganic matrices with embedded photocatalytic capped colloidal nanocrystals.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

Embodiments of the present invention are described by way of example with reference to the accompanying figures, which are schematic and are not intended to be drawn to scale. Unless indicated as representing the prior art, the figures represent aspects of the invention.

Various embodiments of the present disclosure are described by way of example with reference to the accompanying figures, which are schematic and are not intended to be drawn to scale. Unless indicated as representing the prior art, the figures represent aspects of the disclosure.

FIG. 1 is a block diagram of a method for forming a composition of photocatalytic capped colloidal nanocrystals, according to an embodiment.

FIG. 2 shows an embodiment of spherical configuration of photocatalytic capped colloidal nanocrystals.

FIG. 3 illustrates an embodiment of tetrapod configuration of photocatalytic capped colloidal nanocrystals.

FIG. 4 depicts an embodiment of core/shell configuration of photocatalytic capped colloidal nanocrystals.

FIG. 5 illustrates an embodiment of carbon nanotube configuration of photocatalytic capped colloidal nanocrystals.

FIG. 6 shows an embodiment of nanorod configuration of photocatalytic capped colloidal nanocrystals.

FIG. 7 illustrates an embodiment of nanowire configuration of photocatalytic capped colloidal nanocrystals.

FIG. 8 depicts an embodiment of nanospring configuration of photocatalytic capped colloidal nanocrystals.

FIG. 9 depicts an embodiment of nanodendritic configuration of photocatalytic capped colloidal nanocrystals.

FIG. 10 shows an embodiment of spraying deposition method and annealing method used to apply and treat photocatalytic capped colloidal nanocrystals on a substrate.

FIG. 11 illustrates an embodiment of photoactive material employed in the present disclosure.

FIG. 12 depicts an embodiment of charge separation process that may occur during carbon dioxide reduction process using photoactive material containing photocatalytic capped colloidal nanocrystals.

FIG. 13 depicts an embodiment of method for synthesize ZnS semiconductor nanocrystals in nanorod configuration.

FIG. 14 shows an embodiment of method for synthesize ZnS semiconductor nanocrystals in nanowire configuration.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments that may be substituted for the particular examples described herein and still fall within the scope of the invention.

Disclosed herein is a composition and method for producing photocatalytic capped colloidal nanocrystals that may be used as a photoactive material which, according to an embodiment, may be employed in the photocatalytic reduction of carbon dioxide.

Various example embodiments of the present disclosure are described more fully with reference to the accompanying drawings in which some example embodiments of the present disclosure are shown. In the drawings, the thicknesses of layers and regions may be exaggerated for clarity. Detailed illustrative embodiments of the present disclosure are disclosed herein. However, specific structural and functional details disclosed herein are merely representative for purposes of describing example embodiments of the present disclosure. This disclosure however, may be embodied in many alternate forms and should not be construed as limited to only the embodiments set forth herein.

### Definitions

As used here, the following terms may have the following definitions:

“Branched” refers to segments grown onto a semiconductor nanocrystal face or branch in a nonlinear alignment with the semiconductor nanocrystal face or branch.

“Dendritic” refers to tree-shaped or branched-shaped photocatalytic capped colloidal nanocrystals.

“Electron-hole pairs” may refer to charge carriers that are created when an electron acquires energy sufficient to move from a valence band to a conduction band and creates a free hole in the valence band, thus starting a process of charge separation.

“Inorganic capping agent” refers to semiconductor particles that cap semiconductor nanocrystals and act as photocatalysts that quickly transfer electron-hole pairs and begin a reduction-oxidation reaction of carbon dioxide and hydrogen.

“Heteroaggregate” refers to a combination of at least two elements chemically bonded but not alloyed with each other.

“Heterostructure” refers to structures that have one semiconductor material grown into the crystal lattice of another semiconductor material.

“Nanocrystal growth” refers to a synthetic process including the reaction of component precursors of a semiconductor nanocrystal in the presence of a stabilizing organic ligand.

“Photoactive material” may refer to a substance that may be used in photocatalytic processes for absorbing light and starting a chemical reaction with light.

“Segment” refers to a part of a semiconductor nanocrystal material extending longitudinally at an angle from the surface of a photocatalytic capped colloidal nanocrystal.

“Semiconductor nanocrystals” refers to particles sized between about 1 and about 100 nanometers produced using semiconducting materials with large surface areas able to absorb light and initiate an electron-hole pair production that triggers the photochemical reaction of carbon dioxide reduction.

Method for Forming Composition of Photocatalytic Capped Colloidal Nanocrystals

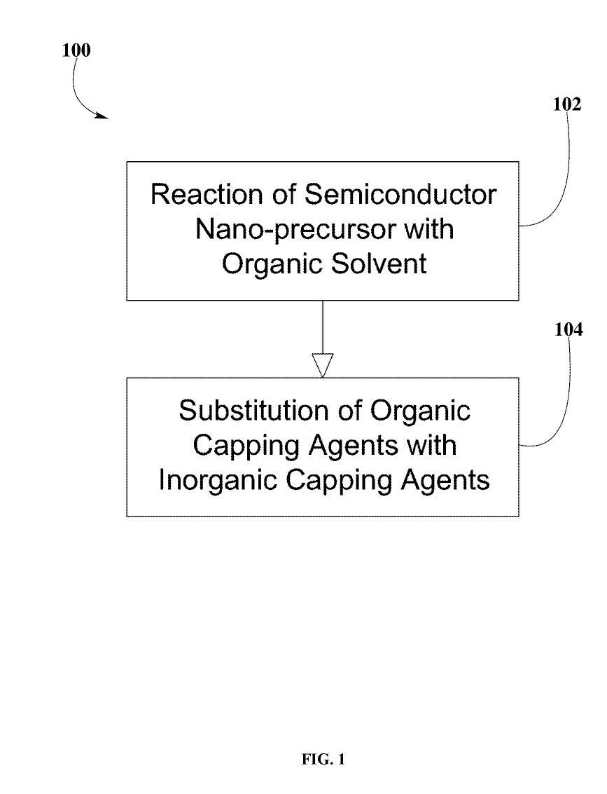

FIG. 1 shows a flow diagram of a method 100 for forming a composition of photocatalytic capped colloidal nanocrystals. Photocatalytic capped colloidal nanocrystals may be synthesized following accepted protocols, and may include one or more semiconductor nanocrystals and one or more inorganic capping agents.

To synthesize photocatalytic capped colloidal nanocrystals, semiconductor nanocrystals are first grown by reacting semiconductor nanocrystal precursors in the presence of an organic solvent 102. Here, the organic solvent may be a stabilizing organic ligand, referred to as organic capping agent. One example of an organic capping agent may be trioctylphosphine oxide (TOPO). TOPO 99% may be obtained from Sigma-Aldrich Co. LLC (St. Louis, Mo.). TOPO capping agent prevents the agglomeration of semiconductor nanocrystals during and after their synthesis. Additionally, the long organic chains radiating from organic capping agents on the surface of semiconductor nanocrystals may assist in the suspension and/or solubility of semiconductor nanocrystals in a solvent. Other suitable organic capping agents may include long-chain aliphatic amines, long-chain aliphatic phosphines, long-chain aliphatic carboxylic acids, long-chain aliphatic phosphonic acids and mixtures thereof.

Examples of semiconductor nanocrystals may include the following: Ag, Au, Ru, Rh, Pt, Pd, Os, Ir, Ni, Cu, CdS, Pt-tipped, TiO₂, Mn/ZnO, ZnO, CdSe, SiO₂, ZrO₂, SnO₂, WO₃, MoO₃, CeO₂, ZnS, WS₂, MoS₂, SiC, GaP, Cu—Au, Ag, and mixtures thereof; Cu/TiO₂, Ag/TiO₂, Cu—Fe/TiO₂—SiO₂ and dye-sensitized Cu—Fe/P25 coated optical fibers.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties or charge carrier mobility. According to conventional methods, a number of synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be employed.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, tetrahedra (tetrapods), among others. Neither the morphology nor the size of semiconductor nanocrystals inhibits method 100; rather, the selection of morphology and size of semiconductor nanocrystals may permit the tuning and control of the properties of photocatalytic capped colloidal nanocrystals.

In alternative embodiments seeking to modify optical properties as well as to enhance charge carriers mobility, semiconductor nanocrystals may be capped by inorganic capping agents in polar solvents instead of organic capping agents. In those embodiments, inorganic capping agents may act as photocatalysts to facilitate a photocatalytic reaction on the surface of semiconductor nanocrystals. Optionally, semiconductor nanocrystals may be modified by the addition of not one but two different inorganic capping agents. In that instance, a reduction inorganic capping agent is first employed to facilitate the reduction half-cell reaction; then, an oxidation inorganic capping agent facilitates the oxidation half-cell reaction.

Inorganic capping agents may take many forms. In some embodiments these agents may be neutral or ionic, or they may be discrete species, either linear or branched chains, or two-dimensional sheets. Ionic inorganic capping agents are commonly referred to as salts, pairing a cation and an anion. The portion of the salt specifically referred to as an inorganic capping agent is the ion that displaces the organic capping agent.

A further embodiment involves substitution of organic capping agents with inorganic capping agents 104. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction rapidly produces insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystals, and inorganic capping agents may bind to that. This process continues until an equilibrium is established between inorganic capping agents and the free inorganic capping agents. Preferably, the equilibrium favors inorganic capping agents. All the steps described above may be carried out in a nitrogen environment inside a glove box.

Some examples of polar solvents may include 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof. Polar solvents like FA, spectroscopy grade, and DMSO, anhydrous, 99.9% may be supplied by Sigma-Aldrich Co. LLC. Suitable colloidal stability of semiconductor nanocrystals dispersions is mainly determined by a solvent dielectric constant, which may range between about 106 to about 47, with about 106 being preferred.

Examples of non-polar or organic solvents may include tertiary-Butanol, pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, and mixtures thereof. Other examples may include alcohol, hexadecylamine (HDA), hydrocarbon solvents at high temperatures.

The purification of inorganic capped semiconductor nanocrystals may require an isolation procedure, such as the precipitation of inorganic product. That precipitation permits those of skill in the art to wash impurities and/or unreacted materials out of the precipitate. Such isolation may allow for the selective application of photocatalytic capped colloidal nanocrystals.

Preferred inorganic capping agents for photocatalytic capped colloidal nanocrystals may include chalcogenides, and zintl ions, where zintl ions refers to homopolyatomic anions and heteropolyatomic anions that have intermetallic bonds between the same or different metals of the main group, transition metals, lanthanides, and/or actinides.

Additionally, inorganic capping agents may include transition metal chalcogenides such as tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, e.g., MoS(Se4)22-, Mo2S62-, and the like.

Suitable compositions of inorganic capping agents for photocatalytic capped colloidal nanocrystalsmay also include polyoxometalates and oxometalates, such as tungsten oxide, iron oxide, gallium zinc nitride oxide, bismuth vanadium oxide, zinc oxide, titanium dioxide, cadmium sulfide, zinc sulfide, among others.

Method 100 may be adapted to produce a wide variety of photocatalytic capped colloidal nanocrystals. Adaptations of method 100 may include adding two different inorganic capping agents to a single semiconductor nanocrystal, adding two different semiconductor nanocrystals to a single inorganic capping agent, adding two different semiconductor nanocrystals to two different inorganic capping agents, and/or additional multiplicities.

The sequential addition of inorganic capping agents to semiconductor nanocrystals may be possible under the disclosed method 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable photocatalytic capped colloidal nanocrystals may include ZnS.TiO₂, TiO₂.CuO, ZnS.RuOₓ, ZnS.ReOₓ, among others.

As used here the denotation ZnS, TiO₂ may refer to ZnS semiconductor nanocrystal capped with TiO₂ inorganic capping agent. Charges on inorganic capping agent are omitted for clarity. This nomenclature [semiconductor nanocrystal]. [inorganic capping agent] is used throughout this description. The specific percentages of semiconductor nanocrystals and inorganic capping agent may vary between different types of photocatalytic capped colloidal nanocrystal.

Structures of Photocatalytic Capped Colloidal Nanocrystal

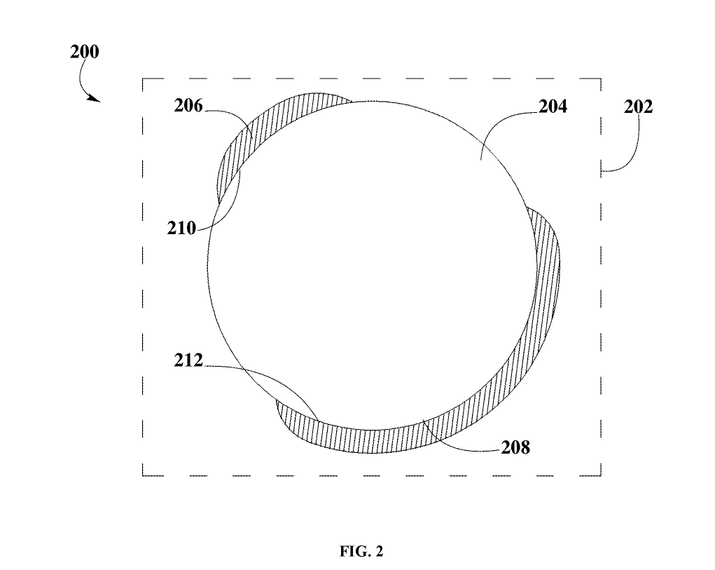

FIG. 2 shows an embodiment of spherical configuration 200 of photocatalytic capped colloidal nanocrystal 202 that may include a single semiconductor nanocrystal 204 capped with first inorganic capping agent 206 and second inorganic capping agent 208. Semiconductor nanocrystal 204 shown in this embodiment may include face A 210 and face B 212; the bond strength of organic capping agent to face A 210 may be twice that of the bond strength to face B 212. Organic capping agents on face B 212 may be preferably exchanged when employing method 100 for forming composition for forming photocatalytic capped colloidal nanocrystals 202 described above. Isolation and reaction of this intermediate species, having organic and inorganic capping agents 106, with second inorganic capping agent 208 may produce photocatalytic capped colloidal nanocrystal 202 with first inorganic capping agent 206 on face B 212 and second inorganic capping agent 208 on face A 210. Alternatively, the preferential binding of inorganic capping agents 106 to specific single semiconductor nanocrystal 204 faces may yield the same result from a single mixture of multiple inorganic capping agents 106.

As an embodiment, single semiconductor nanocrystal 204 may be ZnS, with TiasO₂ as first inorganic capping agent 206 and ReO₂ as second inorganic capping agent 208, therefore forming photocatalytic capped colloidal nanocrystal 202 represented as ZnS.(TiO₂;ReO₂).

Another aspect of method 100 for forming composition is the possibility of a chemical reactivity between first inorganic capping agent 206 and second inorganic capping agent 208. For example, first inorganic capping agent 206 bound to the surface of semiconductor nanocrystal 204 may react with second inorganic capping agent 208. As such, method 100 for forming composition may also provide for the synthesis of photocatalytic capped colloidal nanocrystals 202 that could not be selectively produce from a solution of semiconductor nanocrystals 204 and inorganic capping agents 106. The interaction of first inorganic capping agent 206 with semiconductor nanocrystals 204 may control both the direction and scope of the reactivity of first inorganic capping agent 206 with second inorganic capping agent 208. Furthermore, method 100 for forming composition may control the specific areas where first inorganic capping agent 206 may bind to semiconductor nanocrystal 204. The result of the addition of a combined-inorganic capping agent 106 capping to semiconductor nanocrystal 204 by other methods may produce a random arrangement of the combined-inorganic capping agent 106 on semiconductor nanocrystal 204.

Single core semiconductor nanocrystals 204, such as photocatalytic capped colloidal nanocrystals 202 in spherical configuration 200, can have relatively low quantum efficiencies due to electron-hole recombination occurring at defects and dangling bonds situated on semiconductor nanocrystal 204 surface.

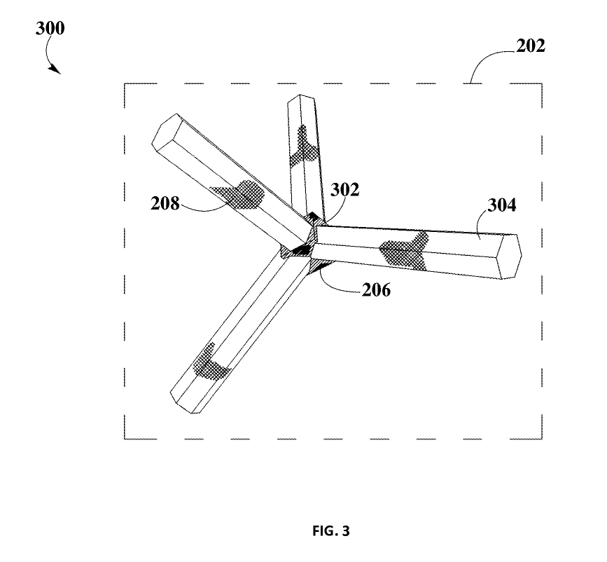

FIG. 3 illustrates an embodiment of tetrapod configuration 300 of photocatalytic capped colloidal nanocrystal 202, including first semiconductor nanocrystal 302 and second semiconductor nanocrystal 304 that may be capped respectively with first inorganic capping agent 206 and second inorganic capping agent 208. Accordingly, first semiconductor nanocrystal 302 may form a cubic core, while second semiconductor nanocrystal 304 may form four arms with hexagonal crystal structures extending from the cubic core. Adjacent arms may form angles of about 109.5 degrees, according to an embodiment. As an example, photocatalytic capped colloidal nanocrystals 202 in tetrapod configuration 300 may include (ZnS;TiO₂). (Cu;TiO₂), in which first semiconductor nanocrystal 302 may be ZnS, capped with TiO₂ as first inorganic capping agent 206, while second semiconductor nanocrystal 304 may be Cu, capped with TiO₂ as second inorganic capping agent 208.

As used herein, semiconductor nanocrystals 204 may include one or more first semiconductor nanocrystal 302 and second semiconductor nanocrystal 304.

Processing conditions of method 100 for forming composition can be adjusted to form arms from the core. Higher monomer concentrations (e.g., adding more precursor to a surfactant mixture) and higher temperatures can be used to induce the formation of second semiconductor nanocrystal 304 branches with hexagonal crystal structures, while lower monomer concentrations and lower temperatures can be used to induce the formation of first semiconductor nanocrystal 302 cubic crystal structures.

According to an embodiment, in tetrapod configuration 300, higher semiconductor nanocrystals 204 ratios may result in longer arms, while more organic capping agents per semiconductor nanocrystal 204 may yield larger arm diameters. Anisotropy, the property of material characteristics being directionally dependent, results from fast growth, and the growth rate may be limited by the concentration of semiconductor nanocrystal precursors 108. Hence, higher first semiconductor nanocrystal 302 to second semiconductor nanocrystal 304 ratios may keep the reaction in the anisotropic growth regime longer, leading to longer second semiconductor nanocrystal 304 arms. On the other hand, the presence of more organic capping agents per first semiconductor nanocrystal 302 may decrease the diffusion constant of the first semiconductor nanocrystal precursors 108 and the driving force for addition to semiconductor nanocrystals 204, thereby slowing the growth rate for a given first semiconductor nanocrystal 302 concentration. However, the growth of second semiconductor nanocrystal 304 arms may continue as long as first semiconductor nanocrystal 302 concentration is sufficiently high. This results may be in less anisotropic branches, with a larger diameter for a given length.

Accordingly, photocatalytic capped colloidal nanocrystals 202 in tetrapod configuration 300 can exhibit a variety of interesting mechanical, electrical, and optical properties. In tetrapod configuration 300, most of the confinement energy may be contained along the diameter of second semiconductor nanocrystal 304 hexagonal arms. Therefore, tetrapods having comparable arm lengths but different diameters, show remarkable differences in band gap energy. On the other hand, light absorbance of tetrapods with comparable diameters but different arm lengths, are almost identical. As such, the critical parameter for tuning the band gaps of photocatalytic capped colloidal nanocrystals 202 in tetrapod configuration 300 is the diameter of second semiconductor nanocrystal 304 hexagonal arms. More specifically, larger diameters may result in higher absorbance spectra of photocatalytic capped colloidal nanocrystals 202, while smaller diameters may result in lower absorbance spectra.

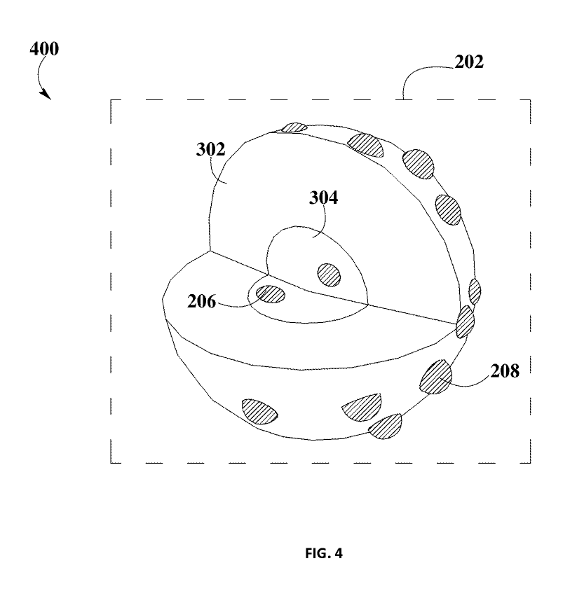

FIG. 4 depicts an embodiment of core/shell configuration 400 of photocatalytic capped colloidal nanocrystals 202 that may include first semiconductor nanocrystal 304 core and second semiconductor nanocrystal 302 shell that may be capped with first inorganic capping agent 206 and second inorganic capping agent 208, respectively. As an example, photocatalytic capped colloidal nanocrystal 202 in core/shell configuration 400 may include (ZnS;Cu).TiO₂, where first semiconductor nanocrystal 302 may be ZnS, while second semiconductor nanocrystal 304 may be Cu, and TiO₂ may be both first inorganic capping agent 206 and second inorganic capping agent 208.

According to example embodiments of the present disclosure, multi-shell photocatalytic capped colloidal nanocrystals 202 may be produced by forming a core first semiconductor nanocrystal 304, and simultaneously reacting two or more semiconductor nanocrystal precursors 108 having different reaction rates to sequentially form at least two shell layers of second semiconductor nanocrystals 302 that may have different compositions on a surface of the core of first semiconductor nanocrystal 304.

One method to eliminate defects and dangling bonds may be to grow second semiconductor nanocrystal 302, having a wider band gap and small lattice mismatch to that of first semiconductor nanocrystal 304 core material, epitaxially on the surface of first semiconductor nanocrystal 302 core. Photocatalytic capped colloidal nanocrystals 202 in core/shell configuration 400 may separate charge carriers confined in first semiconductor nanocrystal 304 core from surface states that would otherwise act as non-radiative recombination centers. As an example, ZnS second semiconductor nanocrystal 302 shell may be grown on the surface of a CdSe first semiconductor nanocrystal 304 core to provide a CdSe/ZnS photocatalytic capped colloidal nanocrystal 202 in core/shell configuration 400.

Second semiconductor nanocrystal 302 shell may typically, although not always, have a thickness between about 0.1 nm and about 10 nm.

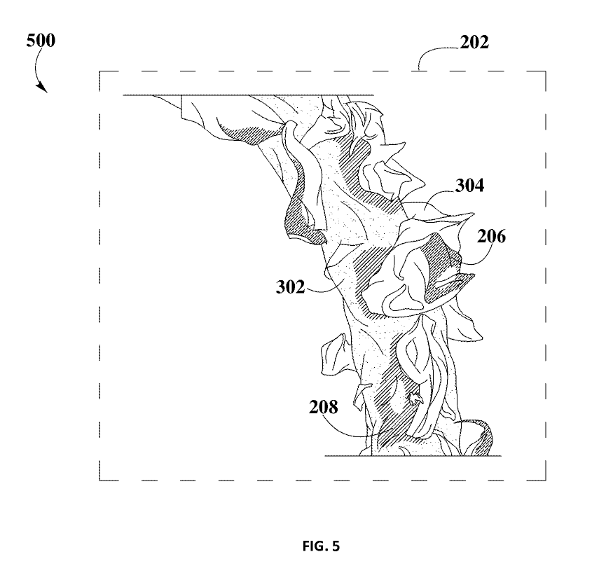

FIG. 5 illustrates an embodiment of carbon nanotube configuration 500 of photocatalytic capped colloidal nanocrystals 202, including first semiconductor nanocrystal 302 and second semiconductor nanocrystal 304 capped with first inorganic capping agent 206 and second inorganic capping agent 208, respectively. As an example, photocatalytic capped colloidal nanocrystal 202 in carbon nanotube configuration 500 may include a carbon nanotube as first semiconductor nanocrystal 302, and graphene foliates as second semiconductor nanocrystal 304; ZnS may be first inorganic capping agent 206 and TiO₂ second inorganic capping agent 208, respectively. Depositing a high density of second semiconductor nanocrystal 304 graphene foliates along the length of aligned first semiconductor nanocrystal 302 carbon nanotube may significantly increase the total charge capacity per unit of nominal area as compared to other carbon nanostructures.

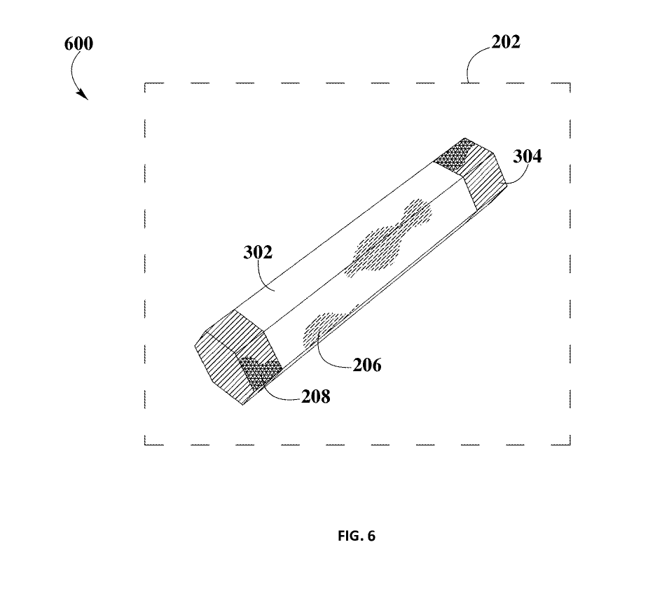

FIG. 6 shows an embodiment of photocatalytic capped colloidal nanocrystals 202 in nanorod configuration 600. According to an embodiment, there may be one ZnS region and two Cu regions as first semiconductor nanocrystal 302 and second semiconductor nanocrystal 304, respectively, where first semiconductor nanocrystal 302 may be larger than each of the two second semiconductor nanocrystal 304 of nanorod configuration 600. In other embodiments, the different regions with different materials may have the same lengths, and there can be any suitable number of different regions. The number of regions per nanorod superlattice in nanorod configuration 600 may vary according to the length of the nanorod.

First semiconductor nanocrystal 302 and second semiconductor nanocrystal 304 may be capped with first inorganic capping agent 206 and second inorganic capping agent 208, respectively. First inorganic capping agent 206 may include ReO₂, while W₂O₃ may be employed as second inorganic capping agent 208. Second semiconductor nanocrystal 304 may be placed at the end points of nanorod configuration 600.

The band gap of photocatalytic capped colloidal nanocrystals 202 in nanorod configuration 600 may depend on the size of first semiconductor nanocrystal 302 and second semiconductor nanocrystal 304, matching the bulk material value for fully converted photocatalytic capped colloidal nanocrystals 202 in nanorod configuration 600 and shifting to higher energy in smaller segments due to quantum confinement. Such structures are of interest for photoactive materials that may result from methods in the present disclosure, where the sparse density of electronic states within photocatalytic capped colloidal nanocrystals 202 may lead to multiple exciton generation.

In nanorod configuration 600, the surface-to-volume ratio is higher than in spherical configuration 200, increasing the occurrence of surface trap-states. In larger segments of first semiconductor nanocrystal 302 and second semiconductor nanocrystals 304, the increased delocalization of charge carriers may reduce the overlap of charge carriers' wave functions, lowering the probability of charge carriers' recombination. The delocalization of charge carriers should be particularly high within nanorod configurations 600, where charge carriers may be free to move throughout the length of the rod.

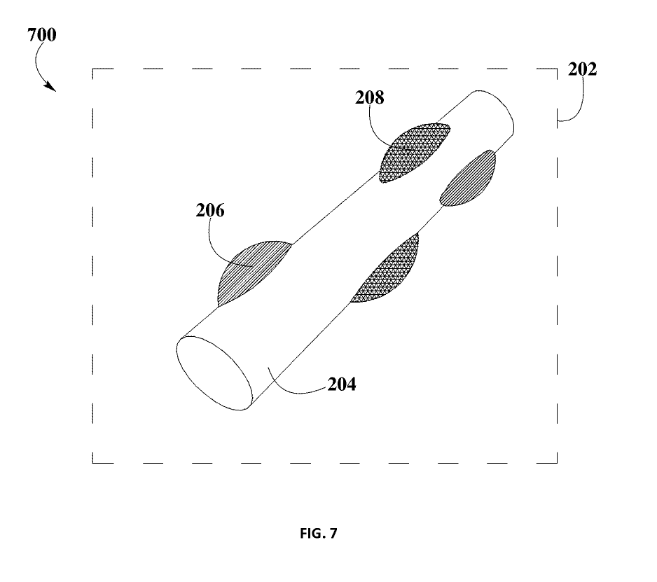

FIG. 7 illustrates an embodiment of photocatalytic capped colloidal nanocrystals 202 in nanowire configuration 700, that may include a single semiconductor nanocrystal 204 capped with first inorganic capping agent 206 and second inorganic capping agent 208. As an example, photocatalytic capped colloidal nanocrystal 202 in nanowire configuration 700 may include ZnS as semiconductor nanocrystal 204, TiO₂ as first inorganic capping agent 206 and ReO₂ as second inorganic capping agent 208.

Nanowire configuration 700 may be precisely controlled during synthesis. Some studies report that conductivity of nanowire configuration 700 may be much less than that of the corresponding bulk material. Also, conductivity of nanowire configuration 700 may be strongly influenced by edge effects. The edge effects come from atoms that lay at the surface of nanowire configuration 700 and are not completely bonded to neighboring atoms similar to the atoms within the bulk of nanowire configuration 700. The unbonded atoms are often a source of defects within nanowire configuration 700, and may cause nanowire configuration 700 to conduct electricity more poorly than the bulk material. As nanowire configuration 700 shrinks in size, the surface atoms become more numerous compared to the atoms within nanowire configuration 700, and edge effects become more important.

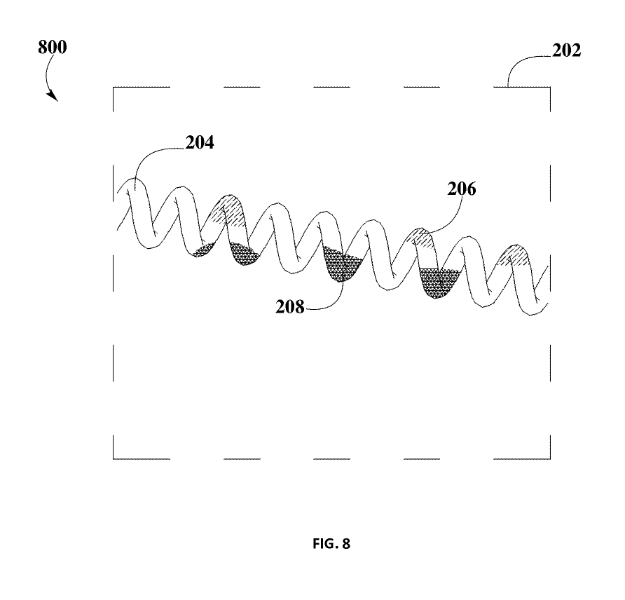

FIG. 8 depicts an embodiment of photocatalytic capped colloidal nanocrystals 202 in nanospring configuration 800, which may include a single semiconductor nanocrystal 204 capped with first inorganic capping agent 206 and second inorganic capping agent 208. As an example, photocatalytic capped colloidal nanocrystal 202 in nanospring configuration 800 may include ZnS as semiconductor nanocrystal 204, TiO₂ as first inorganic capping agent 206 and W₂O₃ as second inorganic capping agent 208.

Nanosprings are spontaneous-polarization-induced structures excellent for understanding electrical and polarization induced phenomena at nanoscale. Nanospring configuration 800 may create a broad surface area and at the same time allows easy movement of fluids.

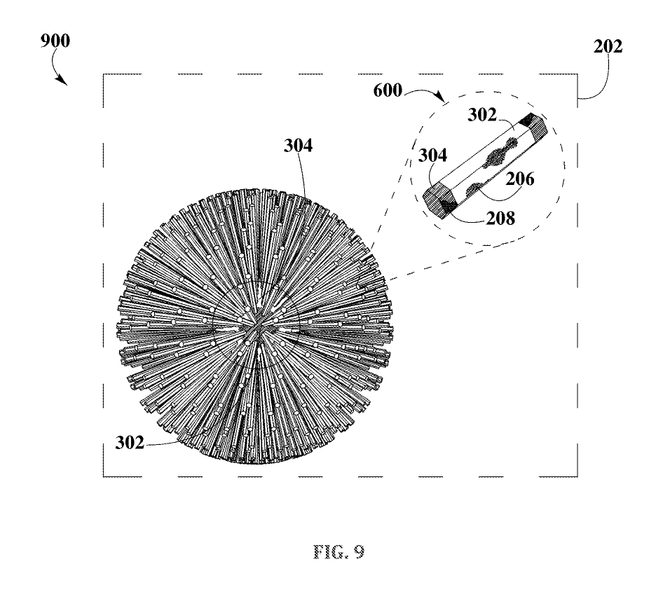

FIG. 9 depicts an embodiment of nanodendritic configuration 900 of photocatalytic capped colloidal nanocrystals 202, which may include a Cu/ZnS highly conductive heteroaggregate dendritic photocatalytic capped colloidal nanocrystal 202. Accordingly, first semiconductor nanocrystal 302 may be surrounded by a plurality of second semiconductor nanocrystals 304, both capped by first inorganic capping agent 206 and second inorganic capping agent 208, respectively. The plurality of second semiconductor nanocrystals 304 may be in nanorod configuration 600 and may provide for a high photocatalytic surface area. Controlled seeding strategies may be employed in order to form nanodendritic configuration 900.

Method for Deposition

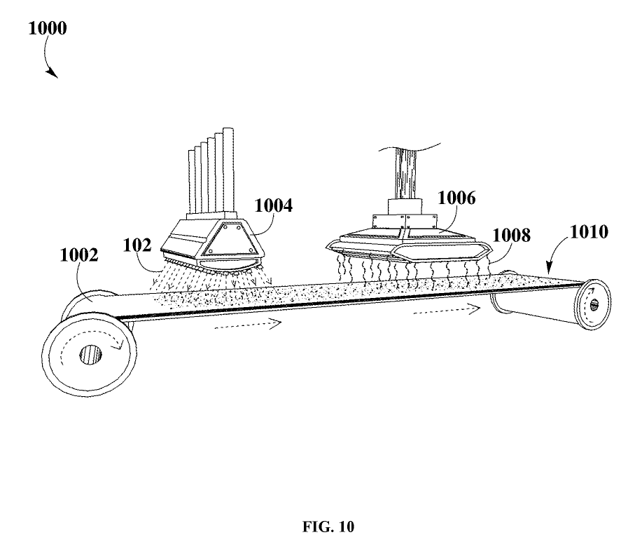

FIG. 10 shows an embodiment of spraying deposition and annealing methods 1000 that may be used to apply and thermally treat photocatalytic capped colloidal nanocrystals 202 composition on substrate 1002. In an embodiment, photocatalytic capped colloidal nanocrystal 202 disclosed herein may be applied on a suitable porous substrate 1002, which may have a pore size sufficient for gas (CO₂, H₂) to pass though at a constant flow rate. In some embodiments, porous substrate 1002 may also be optically transparent in order to allow photocatalytic capped colloidal nanocrystals 202 to receive more light. Suitable porous substrates 1002 may include glass frits, fiberglass cloth, porous alumina and porous silicon. In other embodiments, a non-porous substrate 1002 may be employed. Suitable non-porous substrates 1002 may include polydiallyldimethylammonium chloride (PDDA), polyethylene terephthalate (PET) and silicon.

According to an embodiment, photocatalytic capped colloidal nanocrystals 202 may be applied to substrate 1002 by means of spraying device 1004 during a period of time depending on preferred thickness of photocatalytic capped colloidal nanocrystals 202 composition applied on substrate 1002.

Another aspect of the present disclosure is the thermal treatment of the herein described photocatalytic capped colloidal nanocrystals 202. Many of first inorganic capping agents 206 or second inorganic capping agents 208 may be precursors to inorganic materials (matrices) and low-temperature thermal treatment of first inorganic capping agents 206 or second inorganic capping agents 208 employing convection heater 1006 may provide a gentle method to produce crystalline films from photocatalytic capped colloidal nanocrystals 202. The thermal treatment of photocatalytic capped colloidal nanocrystals 202 may yield, for example, ordered arrays of semiconductor nanocrystals 204 within an inorganic matrix, hetero-alloys, or alloys. In at least one embodiment herein, convection heat 1008 applied over photocatalytic capped colloidal nanocrystals 202 may reach temperatures less than about 350, 300, 250, 200, and/or 180° C.

As a result of spraying deposition and annealing methods 1000, photoactive material 1010 may be formed. Photoactive material 1010 may then be cut into films to be used in energy conversion applications, including photocatalytic carbon dioxide reduction.

In addition to spraying deposition and annealing methods 1000, other deposition methods of photocatalytic capped colloidal nanocrystals 202 may include plating, chemical synthesis in solution, chemical vapor deposition (CVD), spin coating, plasma enhanced chemical vapor deposition (PECVD), laser ablation, thermal evaporation, molecular beam epitaxy, electron beam evaporation, pulsed laser deposition (PLD), sputtering, reactive sputtering, atomic layer deposition and the like.

According to another embodiment, deposition on substrate 1002 may not be needed. Accordingly, photocatalytic capped colloidal nanocrystals 202 may be deposited into a crucible to be then annealed. The solid photocatalytic capped colloidal nanocrystals 202 may then be ground into particles and sintered together to form photoactive material 1010 that may be deposited on a surface where it may adhere. In another embodiment, ground particles may be used directly as photoactive material 1010.

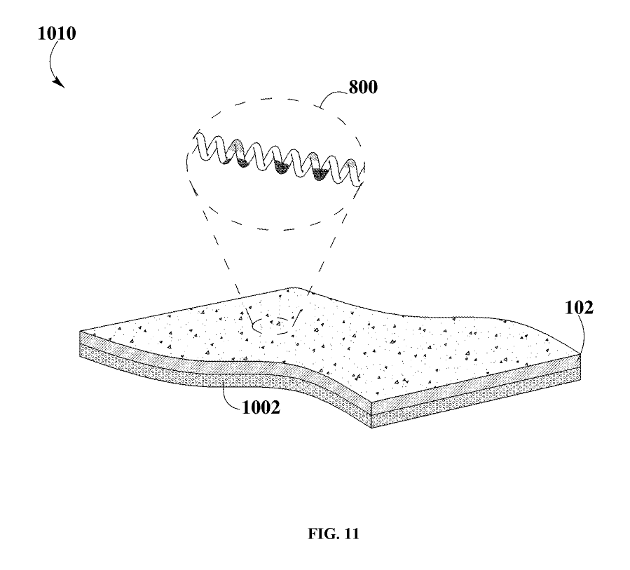

FIG. 11 illustrates and embodiment of photoactive material 1010 including treated photocatalytic capped colloidal nanocrystals 202 composition in nanospring configuration 800 over substrate 1002. In an embodiment, porous alumina may be employed as substrate 1002. Photocatalytic capped colloidal nanocrystals 202 in photoactive material 1010 may also exhibit spherical configuration 200, tetrapod configuration 300, core/shell configuration 400, carbon nanotube configuration 500, nanorod configuration 600, nanowire configuration 700, nanodendritic configuration 900, among others.

In order to measure the performance of photoactive material 1010, devices such as transmission electron microscopy (TEM), and energy dispersive X-ray (EDX), among others, may be utilized. Performance of photoactive material 1010 may be related to light absorbance, charge carriers mobility and energy conversion efficiency.

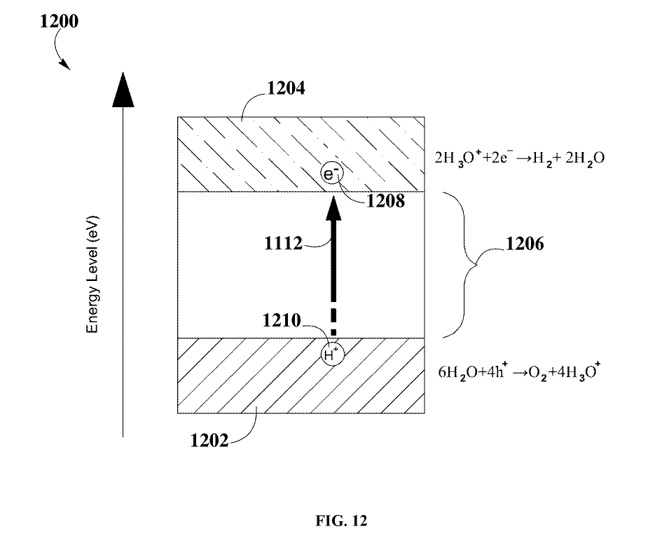

FIG. 12 depicts and embodiment of charge separation process 1200 that may occur in the boundary between photoactive material 1010 and carbon dioxide during a carbon dioxide reduction process.

The energy difference between valence band 1202 and conduction band 1204 of semiconductor nanocrystal 204 is known as band gap 1206. Valence band 1202 refers to the outermost electron 1208 shell of atoms in semiconductor nanocrystals 204 and insulators in which electrons 1208 are too tightly bound to the atom to carry electric current, while conduction band 1204 refers to the band of orbitals that are high in energy and are generally empty. Band gap 1206 of semiconductor nanocrystals 204 should be large enough to drive carbon dioxide reduction process reactions but small enough to absorb a large fraction of light wavelengths. Band gap 1206 of photocatalytic capped colloidal nanocrystal 202 employed in the reduction of carbon dioxide should be at least 1.33 eV, which corresponds to absorption of solar photons of wavelengths below 930 nm. Considering the energy loss associated with entropy change (87 J/mol·K) and other losses involved in carbon dioxide reduction (forming methane and water vapor), band gaps 1206 between about 2 and about 2.4 eV may be preferred. The manifestation of band gap 1206 in optical absorption is that only photons with energy larger than or equal to band gap 1206 are absorbed.

Band gap 1206 energy of quantum-confined semiconductor nanocrystals 204 is strongly size-dependent because size effects can determine absolute positions of the energy quantum-confined states in photocatalytic capped colloidal nanocrystals 202. Additionally, inorganic capping agents 106 can also affect the position of energy levels in photocatalytic capped colloidal nanocrystals 202. The ability to efficiently inject or extract charge carriers may depend on the energy barriers that form at the interfaces between individual semiconductor nanocrystals 204 and also at the interface between semiconductor nanocrystals 204 and inorganic capping agents 106. If contacts do not properly align, a potential barrier may form, leading to poor charge injection and non-ohmic contacts.

In an embodiment, tetrapod configuration 300 is employed for photocatalytic capped colloidal nanocrystals 202 in photoactive material 1010, a type II semiconductor nanocrystal 204 heterostructure may have a base segment of first semiconductor nanocrystal 302 and the branches may be terminated with second semiconductor nanocrystal 304. First semiconductor nanocrystal 302 material and second semiconductor nanocrystal 304 material may be selected so that, upon excitation, one charge carrier (i.e. electron 1208 or hole 1210) is substantially confined to the core and the other carrier is substantially confined to the branches. According to an embodiment, conduction band 1204 of first semiconductor nanocrystal 302 is at higher energy than conduction band 1204 of second semiconductor nanocrystal 304 and valence band 1202 of first semiconductor nanocrystal 302 is at higher energy than valence band 1202 of second semiconductor nanocrystal 304. According to another embodiment, conduction band 1204 of first semiconductor nanocrystal 302 is at lower energy than conduction band 1204 of second semiconductor nanocrystal 304 and valence band 1202 of first semiconductor nanocrystal 302 is at lower energy than valence band 1202 of second semiconductor nanocrystal 304. These band alignments may form a spatial separation of carriers, energetically favorable upon excitation.

According to an embodiment, a type I semiconductor nanocrystals 204 heterostructure is one in which conduction band 1204 of second semiconductor nanocrystal 304 is of higher energy than that of first semiconductor nanocrystal 302, and valence band 1202 of second semiconductor nanocrystal 304 is of lower energy than that of first semiconductor nanocrystal 302. In another embodiment, conduction band 1204 of second semiconductor nanocrystal 304 is of lower energy than that of first semiconductor nanocrystal 302, and valence band 1202 of second semiconductor nanocrystal 304 is of higher energy than that of first semiconductor nanocrystal 302. Type I semiconductor nanocrystal 204 heterostructure may favor confinement of both hole 1210 and electron 1208 in terminal ends.

Semiconductor nanocrystals 204 having type II heterostructures may have advantageous properties over type I heterostructures that may result of the spatial separation of charge carriers. In some semiconductor nanocrystals 204 having type II heterostructures, the effective band gap 1206, as measured by the difference in the energy of emission and energy of the lowest absorption features, can be smaller than band gap 1206 of either of the two semiconductor nanocrystals 204 within photocatalytic capped colloidal nanocrystals 202. By selecting particular first semiconductor nanocrystal 302 materials and second semiconductor nanocrystal 304 materials, and varying thicknesses of semiconductor nanocrystals 204 materials, photocatalytic capped colloidal nanocrystals 202 having type II heterostructures can absorb emission wavelengths, such as infrared wavelengths and near infrared wavelengths, providing for more efficient light extraction for carbon dioxide reduction process and other photocatalytic processes employing photoactive material 1010.

When semiconductor nanocrystals 204 in photoactive material 1010 are irradiated with photons having a level of energy greater than band gap 1206 of photoactive material 1010, electrons 1208 may be excited from valence band 1202 into conduction band 1204, leaving holes 1210 behind in valence band 1202. Excited electrons 1208 may reduce carbon dioxide molecules into methane, while holes 1210 may oxidize hydrogen gas molecules. Oxidized hydrogen molecules may react with carbon dioxide and form water and methane via a series of reactions.

Electrons 1208 may acquire energy corresponding to the wavelength of absorbed light. Upon being excited, electrons 1208 may relax to the bottom of conduction band 1204, which may lead to recombination with holes 1210 and therefore to an inefficient charge separation process 1200.

According to an embodiment, semiconductor nanocrystal 204 in photoactive material 1010 may be capped with first inorganic capping agent 206 and second inorganic capping agent 208 as a reduction photocatalyst and an oxidative photocatalyst, respectively. Following photo-excitation 1112 to conduction band 1204, electrons 1208 can quickly move to the acceptor state of first inorganic capping agent 206 and hole 1210 can move to the donor state of second inorganic capping agent 208, preventing recombination of electrons 1208 and holes 1210. First inorganic capping agent 206 acceptor state and second inorganic capping agent 208 donor state lie energetically between the band edge states and the redox potentials of the methane and water producing half-reactions. The sequestration of the charges into these states may also physically separate electrons 1208 and holes 1210, in addition to the physical charge carriers separation that occurs in the boundaries between individual semiconductor nanocrystals 204. By being more stable to recombination in the donor and acceptor states, charge carriers may be stored for use in redox reactions required for a more efficient charge separation process 1200, and hence, a more productive carbon dioxide reduction process.

Excited electrons 1208 may reduce carbon dioxide molecules into methane, while holes 1210 may oxidize hydrogen gas molecules. Oxidized hydrogen molecules may react with carbon dioxide and form water and methane via the following chemical reactions:

CO₂+2H⁺+2e⁻→HCOOH (1)

HCOOH+2H⁺+2e⁻→HCHO+H₂O (2)

HCHO+2H⁺+2e⁻→CH₃OH (3)

CH₃OH+2H⁺+2e⁻→CH₄+H₂O (4)

These chemical reactions may describe the photocatalytic reduction of carbon dioxide, where electrons 1208 may be obtained from photoactive material 1010 and hydrogen atoms may be obtained from hydrogen gas. Beginning from adsorbed carbon dioxide, formic acid (HCOOH) is formed (1) by accepting two electrons 1208 and adding two hydrogen atoms. Then, formaldehyde (HCHO) and water molecules are formed (2) from the reduction of formic acid by accepting two electrons 1208 and adding two hydrogen atoms. Subsequently, methanol (CH₃OH) is formed (3) when formaldehyde accepts two electrons 1208 and two hydrogen atoms are added to formaldehyde. Finally, methane is formed (4) when methanol accepts two electrons 1208 and two hydrogen atoms are added to methanol. In addition, water is formed as a byproduct of the reaction.

The reduction of carbon dioxide to methane requires reducing the chemical state of carbon from C (4+) to C (4−). Eight electrons 1208 are required for the production of each methane. Taking as a whole, eight hydrogen atoms and eight electrons 1208 progressively transfer to one adsorbed carbon dioxide resulting in the production of one methane molecule. Similarly, oxygen released from carbon dioxide may react with free hydrogen radicals and form water vapor molecules.

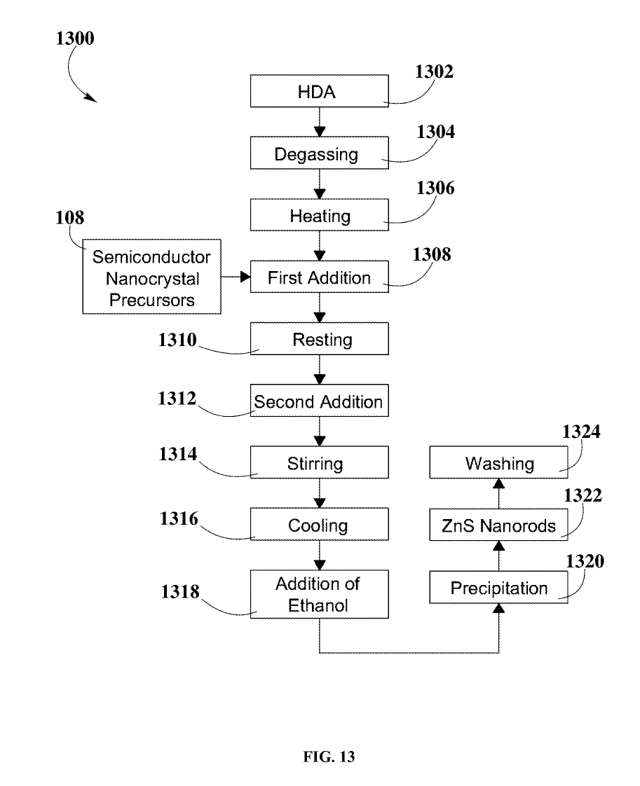

FIG. 13 depicts an embodiment of nanorod synthesis method 1300 for ZnS semiconductor nanocrystals 204, that may be employed in method for forming composition.

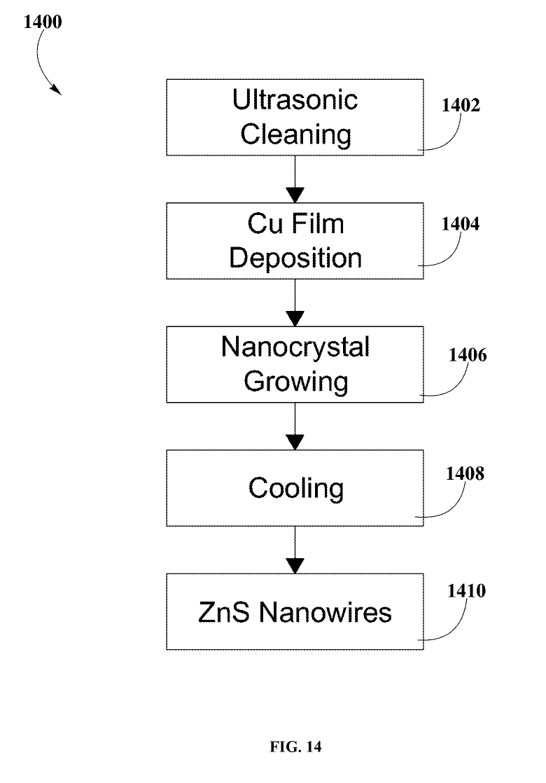

FIG. 14 shows and embodiment of nanowire synthesis method 1400 for ZnS semiconductor nanocrystals 204, which may be employed in method for forming composition.

### EXAMPLES

Example #1 is nanorod synthesis method 1300 to produce ZnS semiconductor nanocrystals 204 in nanorod configuration 600, as shown in FIG. 13. Semiconductor nanocrystals 204 in nanorod configuration 600 may be employed in method for forming composition.

Nanorod synthesis method 1300 may initiate when 100 g of HDA 1302 (hexadecylamine) may pass through degassing process 1304 at a temperature of about 120° C. during about 1 hour. Subsequently, HDA 1302 may undergo heating process 1306, in the presence of nitrogen, at temperatures varying from about 140° C. to about 180° C. Two separate dropping funnels containing solutions of sulfur (1 g, 0.32 mol) in octylamine (30 ml) and zinc acetate dihydrate (3.18 g, 0.32 mol) in octylamine (30 ml) may be employed to control first addition 1308 of semiconductor nanocrystal precursors 108. Afterwards, about 1 ml of zinc stock solution and about 1 ml of sulfur stock solution may be added to semiconductor nanocrystal precursors 108. The solution may be stirred vigorously. Next, the mixture containing semiconductor nanocrystal precursors 108, zinc and sulfur may undergo resting process 1310 for a period of about 30 min at a temperature of about 140° C. Then, second addition 1312 of the rest of the stock solutions (sulfur in octylamine and zinc acetate dihydrate in octylamine) may take place simultaneously at a temperature of about 140° C. during a period of time of about 20 min. After finishing second addition 1312, the solution may undergo stirring process 1314 during about 2 hours. Subsequently, the solution may pass through cooling process 1316 at a temperature of about 80° C. Afterwards, excess ethanol 1318 may be added to the solution in order for precipitation 1320 of ZnS nanorods 1322 to take place. Finally, ZnS nanorods 1322 may be pass through washing process 1324 for about three times employing acetone, in order for unreacted residuals to be removed.

Example #2 is nanowire synthesis method 1400 to produce ZnS semiconductor nanocrystals 204 in nanowire configuration 700, as shown in FIG. 14. Semiconductor nanocrystals 204 in nanowire configuration 700 may be employed in method for forming composition.

Nanowire synthesis method 1400 may be based on thermal evaporation of ZnS powders under controlled conditions with the presence of Cu films used as catalyst. Nanowire synthesis method 1400 may employ a tube furnace system. Anodic aluminum oxide (AAO) template may be employed as substrate 1002. Substrate 1002 may pass through ultrasonic cleaning process 1402 during about 30 minutes in an acetone solution. Subsequently, Cu film 1404 may be deposited on cleaned substrate 1002 during about 15 s, at a pressure of about 10⁻¹ Torr, with a voltage of 100 V and an amperage of about 20 mA, by using an E 1001 film deposition system. In order for nanocrystal growing process 1406 to occur, ZnS powders may be placed at the center of a quartz reaction tube and treated substrate 1002 may be placed next to ZnS powders and along the downstream side of flowing argon ZnS resource temperature may be controlled at about 1020° C. During nanocrystal growing process 1406, 200 sccm Ar and 5 sccm H₂ may be introduced into the quartz reaction tube and the total pressure may be kept at about 150 Torr. After approximately 30 min of deposition for nanocrystal growing process 1406, the solution may undergo cooling process 1408 at temperatures of about 25° C.

Grown ZnS nanowires 1410 may be characterized by a field-emission scanning electron microscope (SEM; S-4200, Hitachi). A transmission electron microscope (TEM; JEM-2010F at 200 KV) equipped with energy-dispersive X-ray (EDX) analysis may be used to characterize ZnS nanowires 1410 and to determine the chemical composition of the same. The PL measurements may be carried out on a visible-ultraviolet spectrophotometer with a lamp as the excitation light source (325 nm) at room temperature.

The embodiments described above are intended to be exemplary. One skilled in the art recognizes that numerous alternative components and embodiments that may be substituted for the particular examples described herein and still fall within the scope of the invention.

What is claimed is:

1. A photocatalytic material comprising:
a colloidal semiconductor nanocrystal; and
a photocatalytic capping agent that binds to a surface of the semicondutor nanocrystal, wherein the photocatalytic capping agent is an inorganic capping agent.

2. The photocatalytic material of claim 1, wherein the photocatalytic material is submerged in hydrogen for a carbon dioxide reduction process.

3. The photocatalytic material of claim 1, wherein the semiconductor nanocrystal comprises one or more of Ag, Au, Ru, Rh, Pt, Pd, Os, Ir, Ni, Cu, CdS, Pt-tipped, TiO₂, Mn/ZnO, ZnO, CdSe, SiO₂, ZrO₂, SnO₂, WO₃, MoO₃, CeO₂, ZnS, WS₂, MoS₂, SiC, GaP, and Cu—Au.

4. The photocatalytic material of claim 1, wherein the semiconductor nanocrystal comprises one morphology from the group consisting of nanocrystals, nanorods, nanoplates, nanowires, nanotubes, dumbbell-like nanoparticles, or dendritic nanomaterials.

5. The photocatalytic material of claim 4, wherein the shape of the morphology comprises a sphere, a cube, or a tetrahedron.

6. The photocatalytic material of claim 1, wherein the photocatalytic capping agent comprises one or more of chalcogenides, zintl ions, transition metals, lanthanides, actinides, tetrasulfides and tetraselenides of vanadium, niobium, tantalum, molybdenum, tungsten, rhenium, tetratellurides of niobium, tantalum, tungsten, the monometallic and polymetallic polysulfides, and polyselenides.

7. The photocatalytic material of claim 1, further comprising:
a second capping agent that binds to the surface of the semiconductor nanocrystal.

8. A photocatalytic capped collodial nanocrystal comprising:
a first semiconductor nanocrystal;
a second semiconductor nanocrystal bonded to the first semiconductor nanocrystal;
a first inorganic capping agent that caps the first semiconductor nanocrystal; and
a second inorganic capping agent that caps the second semiconductor nanocrystal.

9. The photocatalytic capped collodial nanocrystal of claim 8, wherein the first semiconductor nanocrystal forms a cubic core, and the second semiconductor nanocrystal has hexagonal crystal structures extending outwardly from the cubic core.

10. The photocatalytic capped collodial nanocrystal of claim 9, wherein the first semiconductor nanocrystal comprises ZnS, the first inorganic capping agent comprises TiO₂, the second semiconductor nanocrystal comprises Cu, and the second inorganic capping agent comprises TiO₂.

11. The photocatalytic capped collodial nanocrystal of claim 8, wherein the first semiconductor nanocrystal forms a core, and the second semiconductor nanocrystal forms a shell around the core.

12. The photocatalytic capped collodial nanocrystal of claim 8, wherein the first semiconductor nanocrystal forms a carbon nanotube, and the second semiconductor nanocrystal forms graphene foliates.

13. The photocatalytic capped collodial nanocrystal of claim 12, wherein the first inorganic capping agent comprises ZnS, and the second inorganic capping agent comprises TiO₂.

14. The photocatalytic capped collodial nanocrystal of claim 8, wherein the first and second semiconductor nanocrystals form a nanorod, the first semiconductor nanocrystal comprises one ZnS region, the second semiconductor nanocrystal comprises two Cu regions, and the second semiconductor nanocrystal forms at end points of the nanorod.

15. The photocatalytic capped collodial nanocrystal of claim 14, wherein the first inorganic capping agent comprises ReO₂, and the second inorganic capping agent comprises W₂O₃.

16. The photocatalytic capped collodial nanocrystal of claim 8, wherein the first inorganic capping agent is a reduction photocataylst, and the second inorganic capping agent is an oxidative photocatalyst.

17. A method for forming a photocatalytic capped collodial nanocrystal comprising:
reacting a semiconductor nanocrystal precursor and an organic solvent to produce organic capped semiconductor nanocrystals in a non-polar solution;
dissolving an inorganic capping agent in an immiscible, polar solvent to form a polar solution, wherein the inorganic capping agent is a photocatalytic capping agent;
combining the polar solution and the non-polar solution in a reaction vessel;
replacing the organic capping agent with the inorganic capping agent to form inorganic capped semiconductor nanocrystals;
purifying the inorganic capped semiconductor nanocrystals;
depositing the inorganic capped semiconductor nanocrystals on a porous substrate;
heating the deposited inorganic capped semiconductor nanocrystals according to a thermal treatment; and
annealing the inorganic capped semiconductor nanocrystals to form inorganic matrices with embedded photocatalytic capped colloidal nanocrystals.

18. The method of claim 17, wherein the organic solvent comprises one or more of a stabilizing organic ligand, trioctylphosphine oxide, long-chain aliphatic amines, long-chain aliphatic phosphines, long-chain aliphatic carboxylic acids, and long-chain aliphatic phosphonic acids.

19. The method of claim 17, wherein the reaction of the semiconductor nanocrystal precursor and the organic solvent is performed by a colloidal route, a high-temperature and high-pressure autoclave-based method, a high temperature solid state reaction, or a template-assisted synthetic method.

20. The method of claim 17, wherein the polar solvent comprises one or more of 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, and water.

21. The method of claim 17, wherein the organic solvent comprises one or more of tertiary-Butanol, pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, alcohol, hexadecylamine (HDA), and hydrocarbon solvents at high temperatures.

22. The method of claim 17, wherein the porous substrate comprises glass frits, fiberglass cloth, alumina, or silicon.

23. The method of claim 17, wherein the inorganic capped semiconductor nanocrystals are deposited on a porous substrate by plating, chemical synthesis in solution, chemical vapor deposition (CVD), spin coating, plasma enhanced chemical vapor deposition (PECVD), laser ablation, thermal evaporation, molecular beam epitaxy, electron beam evaporation, pulsed laser deposition (PLD), sputtering, reactive sputtering, or atomic layer deposition.

24. The method of claim 17, wherein the photocatalytic capped colloidal nanocrystals have a spherical, tetrapod, core/shell, graphene, carbon nanotubes, nanorods, nanowires, nanosprings, or nanodendritic configuration.

25. The method of claim 24, wherein the configuration varies based on changing a reaction time, changing a reaction temperature profile, changing a structure of the organic capping agents, a chemistry of the organic and inorganic capping agents, or adding more semiconductor nanocrystal precursor.
